(19) United States
(12) Patent Application Publication
(10) Pub. No.: US 2007/0132904 A1
(43) Pub. Date: Jun. 14, 2007

(54) Liquid crystal display of using dual select diode

(76) Inventors: Sung-Jin Hong, Seoul (KR); Chong-Chul Chai, Seoul (KR); Kyoung-Ju Shin, Gyeonggi-do (KR); Joon-Hak Oh, Seoul (KR); Jin-Hong Kim, Seoul (KR)

Correspondence Address: CANTOR COLBURN, LLP, 55 GRIFFIN ROAD SOUTH, BLOOMFIELD, CT, 06002, US

(21) Appl. No.: 10/577,675

(22) PCT Filed: Oct. 28, 2004
(86) PCT No.: PCT/KR04/02740

§ 371 Date: Apr. 28, 2006

(30) Foreign Application Priority Data
Oct. 29, 2003 (KR) 10-2003-0075873

(51) Int. Cl. G02F 1/136

(52) U.S. Cl. 349/50

(57) ABSTRACT

A liquid crystal display comprising: a first insulating sub-strate; first and second gate lines (121,122) formed on the first insulating substrate; a pixel electrode (190) formed on the first insulating substrate; a first MIM diode (D1) formed on the first insulating substrate connecting the first gate line (121) and the pixel electrode (190); a second MIM diode (D2) formed on the first insulating substrate connecting the second gate line (122) and the pixel electrode (190); a second insulating substrate (210) facing the first insulating substrate; and a data electrode line (270) formed on the second insulating substrate and intersecting the first and second gate lines (121,122), and wherein the data electrode line (270) includes protrusions toward right and left sides by turns to overlap a predetermined number of pixel electrodes (190) of the right and left sides by turns is provided.

### BACKGROUND OF THE INVENTION

(a) Field of the Invention

The present disclosure relates to thin film diode array panels using metal insulator metal (MIM) diodes as switching elements, and a manufacturing method of the same. In more detail, the present disclosure relates to thin film diode array panels of a dual select diode (DSD) type, and a liquid crystal display using the same.

(b) Description of the Related Art

A liquid crystal display (LCD) is one of the most widely used flat panel displays. An LCD includes two panels provided with field-generating electrodes, and a liquid crystal (LC) layer interposed therebetween. The LCD displays images by applying voltages to the field-generating electrodes to generate an electric field in the LC layer, which determines orientations of LC molecules in the LC layer to adjust polarization of incident light.

An LCD may have switching elements to switch voltages of pixels arranged in a matrix form. An LCD can display various images since pixel voltages are individually switched. An LCD having switching elements to switch pixel voltages individually is called an active matrix LCD.

Thin film transistors or thin film diodes may be used as the switching elements. When thin film diodes are applied, MIM diodes can be used.

A MIM diode has two metal layers and one insulating layer interposed between the metal layers, and a thickness capable of being measured in micrometers. A MIM diode may act as a switch due to electrical non-linearity of the insulating layer. A MIM diode has two terminals, and as a result, the manufacturing process of the MIM diode is simpler than that of the thin film transistor having three terminals. Accordingly, MIM diodes can be manufactured at a lower cost than thin film transistors.

However, when diodes are used as switching elements, the uniformity of image quality and contrast ratio may be degraded due to asymmetry of an applied voltage with respect to the polarity.

In response to the asymmetry, a dual select diode (DSD) panel has been developed. A DSD panel includes two diodes that are symmetrically connected to a pixel electrode and are driven by applying voltages of opposite polarities.

A DSD LCD shows improved image quality, contrast ratio, gray scale uniformity, and response speed by applying voltages having opposite polarities to two diodes that are connected to the same pixel electrode. Accordingly, a DSD type of LCD can display images with high resolution like that of an LCD using thin film transistors.

A DSD LCD is driven as follows.

When a voltage greater than the critical voltage is applied to a MIM diode, the channel of the MIM diode is opened to charge a pixel electrode connected thereto. On the contrary, when no signal voltage is applied to the MIM diode, the charged voltage is preserved in a liquid crystal capacitor formed between the pixel electrode and a data electrode line, since the channels of the MIM diode are closed.

It is preferable that the charged voltage of the liquid crystal capacitor is stable. However, the charged voltage of the liquid crystal capacitor is not stable due to an influence of voltage of adjacent pixels and data lines. When the charged voltage of the liquid crystal capacitor varies, brightness of the pixel also varies to result in degrading image quality.

### SUMMARY OF THE INVENTION

The present invention is for improving stability of a charged voltage of a liquid crystal capacitor to improve image quality of a DSD LCD.

The present invention provides a liquid crystal display comprising: a first insulating substrate; first and second gate lines formed on the first insulating substrate; a pixel electrode formed on the first insulating substrate; a first MIM diode formed on the first insulating substrate connecting the first gate line and the pixel electrode; a second MIM diode formed on the first insulating substrate connecting the second gate line and the pixel electrode; a second insulating substrate facing the first insulating substrate; and a data electrode line formed on the second insulating substrate and intersecting the first and second gate lines, and wherein the data electrode line includes protrusions protruding toward right and left sides by turns to overlap a predetermined number of pixel electrodes of right and left side by turns.

The liquid crystal display may further comprise a black matrix, a color filter, and an overcoating layer disposed between the second insulating substrate and the data electrode line. The main element of the black matrix may be an organic material.

When a column direction represents the length direction of the data electrode line, the period of the right and left protrusions is the column direction length of two pixels.

The first MIM diode includes a first input electrode connected to the first gate line, a first contact portion connected to the pixel electrode, a first channel insulating layer formed on the first input electrode and the first contact portion, and a first floating electrode formed on the first channel insulating layer and intersecting the first input electrode and the first contact portion; and the second MIM diode includes a second input electrode connected to the second gate line, a second contact portion connected to the pixel electrode, a second channel insulating layer formed on the second input electrode and the second contact portion, and a second floating electrode formed on the second channel insulating layer and intersecting the second input electrode and the second contact portion.

Two adjacent data electrode lines may be applied with signal voltages having opposite polarities to each other.

The first gate line and the pixel electrode may be made of ITO or IZO.

### BRIEF DESCRIPTION OF THE DRAWINGS

Preferred embodiments of the present invention can be understood in more detail from the following descriptions taken in conjunction with the accompanying drawings, in which:

FIG. 1 is a perspective view of a liquid crystal display according to an embodiment of the present invention;

FIG. 2 is a layout view of a liquid crystal display according to an embodiment of the present invention;

FIG. 3 is a sectional view of the liquid crystal display taken along the line III-III′ of FIG. 2 according to an embodiment of the present invention;

FIG. 4 is a layout view of a liquid crystal display showing polarity of pixels when column inversion driving is applied.

FIG. 5 is a waveform diagram of data signal voltages applied to data electrode lines to make polarity of the pixels as shown in FIG. 4.

FIG. 6 is a layout view of a liquid crystal display showing polarity of pixels when the dot inversion driving is applied.

FIG. 7 is a waveform diagram of data signal voltages applied to data electrode lines to make polarity of the pixels as shown in FIG. 6.

FIG. 8 is a waveform diagram of data signal voltage, scanning signal voltage, and liquid crystal voltage.

### DETAILED DESCRIPTION OF THE PREFERRED EMBODIMENTS

Preferred embodiments of the present invention now will be described more fully hereinafter with reference to the accompanying drawings, in which preferred embodiments of the invention are shown. The present invention may, however, be embodied in different forms and should not be construed as being limited to the embodiments set forth herein. Rather, these embodiments are provided so that this disclosure will be thorough and complete, and will fully convey the scope of the invention to those skilled in the art.

In the drawings, the thickness of layers, films, and regions are exaggerated for clarity. Like numerals refer to like elements throughout. It will be understood that when an element such as a layer, film, region, or substrate is referred to as being “on” another element, it can be directly on the other element or intervening elements may also be present.

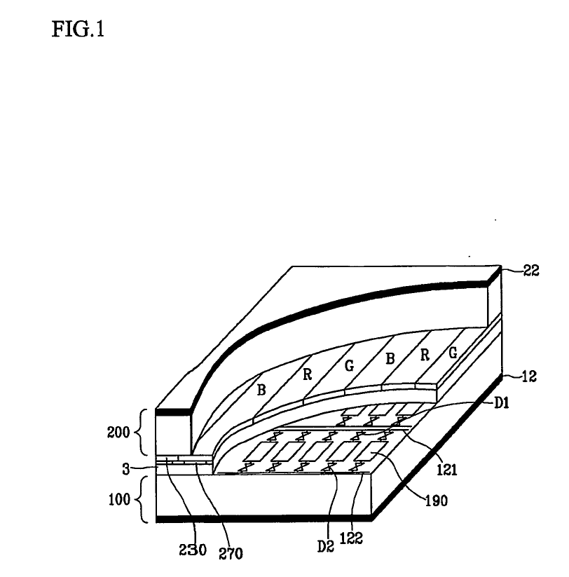

FIG. 1 is a perspective view of a liquid crystal display according to an embodiment of the present invention. As shown in FIG. 1, the liquid crystal display has a lower panel (a thin film diode array panel) 100, an upper panel (a color filter array panel) 200 facing the lower panel 100, and a liquid crystal layer 3 interposed between the two panels 100 and 200 and having liquid crystal molecules aligned in a horizontal direction with respect to the surfaces of the panels 100 and 200.

The lower panel 100 has a plurality of pixel electrodes 190 formed on corresponding regions with red, green, and blue pixels; a plurality of pairs of gate lines 121 and 122 transmitting signals having opposite polarities; and a plurality of MIM diodes D1 and D2 which are switching elements.

The upper panel 200 includes a plurality of data electrode lines 270 forming an electric field along with the pixel electrode 190 for driving liquid crystal molecules and defining pixel regions by intersecting the pairs of gate lines 121 and 122, and a plurality of red, green, and blue color filters 220 which respectively correspond with pixel areas to define red, green, and blue pixel areas. White pixel areas on which no color filter is formed may also be included.

Henceforth, a structure of a thin film diode array panel 100 according to an embodiment of the present invention will be described in detail.

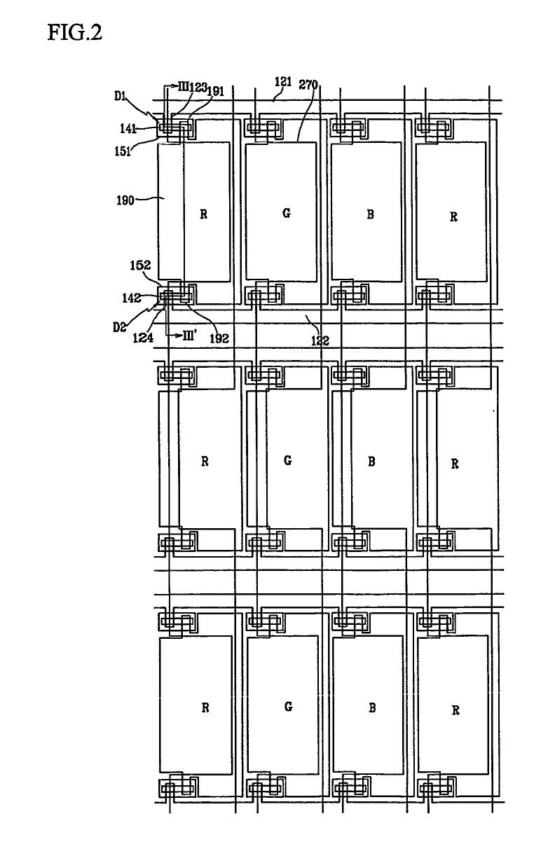

FIG. 2 is a layout view of a liquid crystal display according to an embodiment of the present invention.

As shown in FIG. 2, a liquid crystal display according to an embodiment of the present invention has red pixels (R), green pixels (G), and blue pixels (B) arranged in a matrix shape. As an example, the red, green, and blue pixels are sequentially and repeatedly shown along a row, and the same colored pixels are shown along a column. In other words, red, green, and blue pixels columns are arranged in parallel to each other to make stripes.

The arrangement order of the red, green, and blue pixel may be changed in various ways, and a white pixel may be included.

In the above described LCD, a set of the red, green, and blue pixels forms a dot which is a basic unit of images. The size of each pixel is uniform.

Henceforth, a structure of a thin film diode array panel 100 and upper panel 200 according to an embodiment of the present invention will be described in more detail.

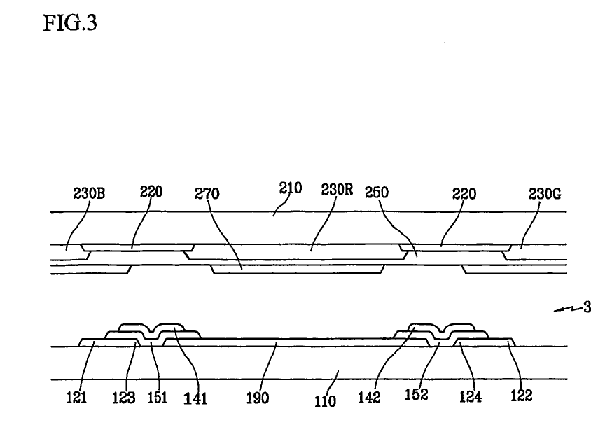

FIG. 3 is a sectional view of the liquid crystal display taken along the line III-III′ of FIG. 2 according to an embodiment of the present invention.

The thin film diode array panel 100 will be described.

As shown in FIGS. 2 and 3, a plurality of pixel electrodes 190 made of a transparent conductor such as indium tin oxide (ITO) and indium zinc oxide (IZO) are formed on a transparent insulating substrate 110 such as a glass.

The pixel electrodes 190 are electrically connected to first and second gate lines 121 and 122, which extend in a transverse direction through MIM diodes D1 and D2.

The pixel electrodes 190 may be made of a conductor having good light reflectivity, such as aluminum (Al) and silver (Ag), for a reflection-type LCD.

In more detail, each pixel electrode 190 is formed in a pixel region on the insulating substrate 110. The pixel electrode 190 includes a first contact portion 191 and a second contact portion 192.

The first and second gate lines 121 and 122 transmitting scanning signals are respectively disposed at upper and lower sides of the pixel region on the insulating substrate 110. First and second input electrodes 123 and 124 respectively connected to the first and second gate lines 121 and 122 extend toward each other. The first and second input electrodes 123 and 124 are respectively adjacent to the first and second contact portions 191 and 192 of the pixel electrode 190 with a predetermined gap therebetween.

It is preferable that the first and second gate lines 121 and 122 are made of the same material as the pixel electrode 190, for simplifying manufacturing processes. However, when another purpose such as reducing resistance is more important, the first and second gate lines 121 and 122 may be made of a different material from the pixel electrode 190. In this case, the first and second gate lines 121 and 122 may be made of one of aluminum (Al), chromium (Cr), thallium (Ta), molybdenum (Mo), and their alloys.

First and second channel insulating layers 151 and 152 are respectively formed on the first and second input electrodes 123 and 124. The first and second insulating layers 151 and 152 are made of silicon nitride (SiNx).

The first channel insulating layer 151 is regionally disposed on the first input electrode 123 and the first contact portion 191. The second channel insulating layer 152 is regionally disposed on the second input electrode 124 and the second contact portion 192. However, the channel insulating layer 151 and 152 may be formed on the whole area of the insulating substrate 110. In this case, the channel insulating layer has contact holes to connect the gate lines 121 and 122 to an external circuit.

A first floating electrode 141 is formed on the first channel insulating layer 151 to intersect the first input electrode 123 and the first contact portion 191. A second floating electrode 142 is formed on the second channel insulating layer 152 to intersect the second input electrode 124 and the second contact portion 192.

The upper panel 200 includes a insulating substrate 210, a black matrix 220, a plurality of red, green, and blue color filters 230R, 230G, and 230B, an overcoating layer 250 formed on the color filters 230R, 230G, and 230B, and a plurality of data electrode lines 270 formed on the overcoating layer 250.

Here, the data electrode lines 270 substantially extend in a longitudinal direction along boundary lines of left and right pixels, and have protrusions periodically protruding toward right and left sides. The right and left protrusions alternately appear. Accordingly, the data electrode line 270 alternately overlaps the right side pixel electrode 270 and the left side pixel electrode 270. For example, the data electrode line 270 between the first and second pixel columns overlaps the pixel electrodes of the second pixel column and the first pixel row, the first pixel column and the second pixel row, the second pixel column and the third pixel row, the first pixel column and the fourth pixel row, etc.

The period of right and left protrusions may be changed. For example, a protrusion of the data electrode lines 270 may be formed to overlap two pixel electrodes in a row. In this case, the column direction length of four pixels is the period of right and left protrusions.

The black matrix 220 is formed of a chrome single layer or a chrome and chrome oxide double layer. The black matrix 220 may be made of an organic material. When the black matrix 220 is made of an organic material, stress of the substrate 210 is reduced. An organic black matrix is useful for a flexible display.

The black matrix 220 is disposed on the MIM diodes and boundary of pixels.

The overcoating layer 250 may be made of silicon nitride or silicon oxide. However, it is preferable for forming an even surface that the overcoating layer 250 is made of an organic insulating material.

The data electrode line 270 is made of a transparent conductor such as ITO and IZO. The data electrode line 270 overlaps the pixel electrodes 190 and a liquid crystal layer 3 is interposed between the data electrode line 270 and the pixel electrodes 190 to form liquid crystal capacitors.

The first floating electrode 141, the first input electrode 123, the first contact portion 191, and the first channel insulating layer 151 interposed between them form a first MIM diode D1. The second floating electrode 142, the second input electrode 124, the second contact portion 192, and the second channel insulating layer 152 interposed between them form a second MIM diode D2.

Due to the nonlinearity of voltage-current characteristics of the channel insulating layer 151 and 152, the first and second MIM diodes D1 and D2 permit the pixel electrode 190 to be charged only when a voltage over the critical voltage of the channel insulating layers 151 and 152 is applied. On the contrary, when no signal voltage is applied to the MIM diodes D1 and D2, the charged voltage is preserved in a liquid crystal capacitor formed between the pixel electrode 190 and a data electrode line 270, since the channel of the MIM diodes M1 and M2 are closed.

When an LCD is manufactured to have above described structure, the dot inversion driving effect is achieved by performing column inversion driving. It diminishes variance of liquid crystal voltage to improve contrast ratio and image quality and to reduce power consumption.

Henceforth, the reason why the above-described effect is achieved will be described.

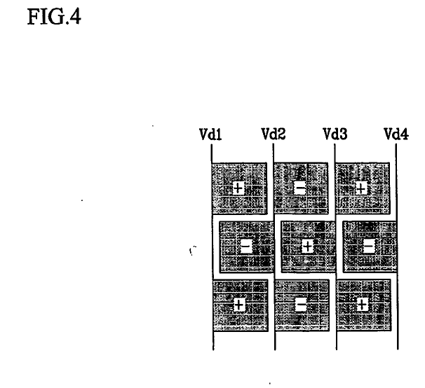

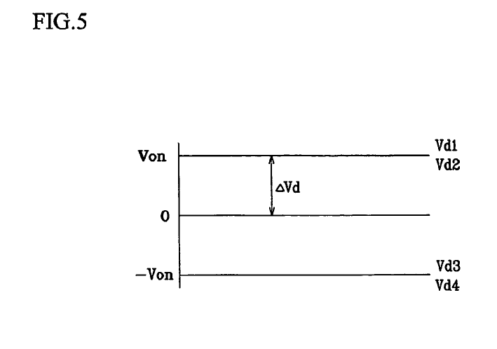

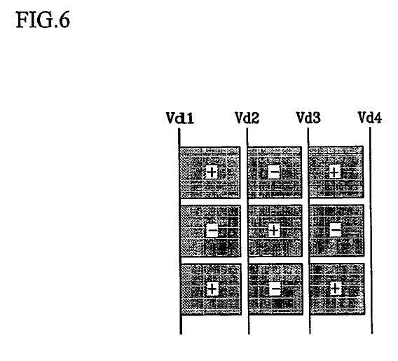

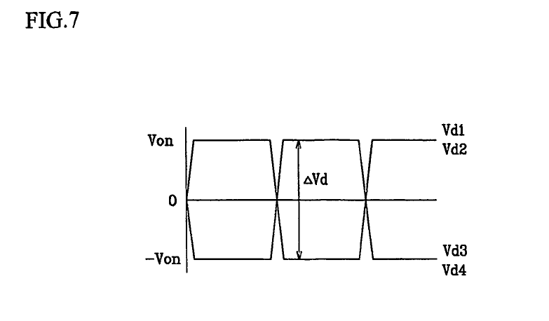

FIG. 4 is a layout view of a liquid crystal display showing polarity of pixels when the column inversion driving is applied. FIG. 5 is a waveform diagram of data signal voltages applied to data electrode lines to make polarity of the pixels as shown in FIG. 4. FIG. 6 is a layout view of a liquid crystal display showing polarity of pixels when the dot inversion driving is applied. FIG. 7 is a waveform diagram of data signal voltages applied to data electrode lines to make polarity of the pixels as shown in FIG. 6.

With reference to FIG. 4, when the data electrode lines are applied with data signal voltages which have inversed polarity line by line, the dot inversion driving feature is achieved due to the shape of the data electrode line protruding to the right and left sides by turns.

FIG. 5 shows voltage waveforms that are applied to the data electrode lines for achieving the dot inversion driving.

As shown in FIG. 5, Vd1 and Vd3 are Von and Vd2 and Vd4 are 31 Von for one frame time. Accordingly, when a voltage variance due to gray scaling is considered, the largest voltage variance (ΔV_{data}) of each data electrode line for one frame time is Von.

However, in a conventional LCD, each data electrode line Vd1, Vd2, Vd3, and Vd4 needs to be applied with a voltage swing between Von and −Von, as shown in FIG. 7, for achieving the dot inversion driving. Accordingly, when a voltage variance due to gray scaling is considered, the largest voltage variance (ΔV_{data}) of each data electrode line for one frame time is 2Von.

When the voltage variance of the data electrode lines is diminished, power consumption is reduced.

Further, when a voltage variance of the data electrode line is diminished, a variance of the liquid crystal voltage (V_{LC}) is also diminished. Henceforth, the reason for this will be described.

Factors inducing variance of the liquid crystal voltage when MIM diodes are off are a variance of the gate line voltage, a variance of the data electrode lines voltage, a voltage variance of adjacent pixels, etc.

In a DSD type of LCD, the variance of the gate line voltage does not affect the liquid crystal voltage (V_{LC}), since gate signal voltages having opposite polarities are simultaneously applied to the first and second gate lines to offset their influence.

The variance of liquid crystal voltage (ΔV_{LC}) induced by the variance of the data electrode line voltage (ΔV_{data}) is caused by parasitic capacitance (C_{MIM}) which is formed due to the structure of the MIM diodes connected to the pixel electrode. The variance of liquid crystal voltage (ΔV_{LC}) induced by the variance of the data electrode line voltage (ΔV_{data}) is represented by the following expression. In the expression, C_{LC} represents liquid crystal capacitance, and ΔVₚ represents the variance of the pixel electrode voltage, which is floating.

$$Δ {V}_{p} = \frac{{C}_{LC}}{{C}_{LC} + {C}_{MIM}} \times Δ {V}_{data}$$

$$Δ {V}_{LC} = Δ {V}_{data} - Δ {V}_{p} = \frac{2 {C}_{LC}}{{C}_{LC} + {C}_{MIM}} \times Δ {V}_{data}$$

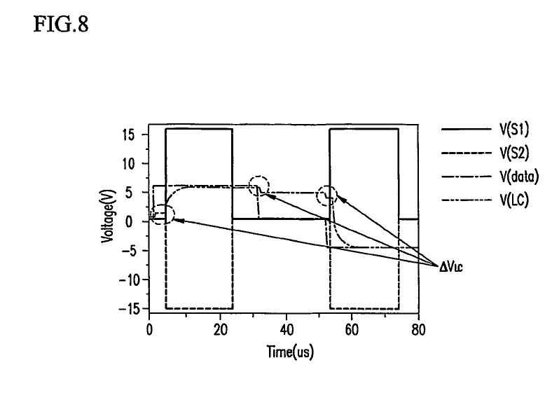

FIG. 8 is a waveform diagram of data signal voltage, scanning signal voltage, and liquid crystal voltage.

As shown in FIG. 8, the variance of liquid crystal voltage (ΔV_{LC}) appears whenever the voltage of the data electrode line varies.

With reference to the above expression, ΔV_{LC} is in proportion to ΔV_{data}. Accordingly, the variance of the liquid crystal voltage (ΔV_{LC}) is reduced when the data electrode line voltage (ΔV_{data}) is reduced. Hence, in the above described embodiment of the present invention, the largest voltage variance (ΔV_{data}) of each data electrode line is reduced by Von with reference to the conventional LCD. As a result, the variance of the liquid crystal voltage (ΔV_{LC}) is also reduced.

The variance of a liquid crystal voltage due to the voltage variance of adjacent pixels can be disregarded when the dot inversion driving is applied. This is because pixels having opposite polarities are symmetrically disposed around a certain pixel to offset their influence.

According to an embodiment for the present invention, the dot inversion driving effect is achieved by performing column inversion driving. It diminishes variance of liquid crystal voltage to improve contrast ratio and image quality and to reduce power consumption.

Although the illustrative embodiments have been described herein with reference to the accompanying drawings, it is to be understood that the present invention is not limited to those precise embodiments, and that various changes and modifications may be affected therein by one of ordinary skill in the related art without departing from the scope or spirit of the invention. All such changes and modifications are intended to be included within the scope of the invention as defined by the appended claims.

What is claimed is:

1. A liquid crystal display comprising:
a first insulating substrate;
first and second gate lines formed on the first insulating substrate;
a pixel electrode formed on the first insulating substrate;
a first MIM diode formed on the first insulating substrate connecting the first gate line and the pixel electrode;
a second MIM diode formed on the first insulating substrate connecting the second gate line and the pixel electrode;
a second insulating substrate facing the first insulating substrate; and
a data electrode line formed on the second insulating substrate and intersecting the first and second gate lines, and
wherein the data electrode line includes protrusions protruding toward right and left sides by turns to overlap a predetermined number of pixel electrodes of the right and left sides by turns.

2. The liquid crystal display of claim 1, further comprising a black matrix, a color filter, and a overcoating layer disposed between the second insulating substrate and the data electrode line.

3. The liquid crystal display of claim 1, wherein when a column direction represents the length direction of the data electrode line, the period of the right and left protrusions is the column direction length of two pixels.

4. The liquid crystal display of claim 2, wherein a main element of the black matrix is an organic material.

5. The liquid crystal display of claim 1, wherein the first MIM diode includes a first input electrode connected to the first gate line, a first contact portion connected to the pixel electrode, a first channel insulating layer formed on the first input electrode and the first contact portion, and a first floating electrode formed on the first channel insulating layer and intersecting the first input electrode and the first contact portion; and
the second MIM diode includes a second input electrode connected to the second gate line, a second contact portion connected to the pixel electrode, a second channel insulating layer formed on the second input electrode and the second contact portion, and a second floating electrode formed on the second channel insulating layer and intersecting the second input electrode and the second contact portion.

6. The liquid crystal display of claim 1, wherein two adjacent data electrode lines are applied with signal voltages having opposite polarities to each other.

7. The liquid crystal display of claim 1, wherein the first gate line and the pixel electrode are made of indium tin oxide (ITO) or indium zinc oxide (IZO).
